(19) United States
(12) Patent Application Publication
(10) Pub. No.: US 2026/0012354 A1
(43) Pub. Date: Jan. 8, 2026

(54) SIGNATURE SYSTEM, TERMINAL, EXISTENCE CONFIRMATION METHOD, AND PROGRAM

(71) Applicant: NIPPON TELEGRAPH AND TELEPHONE CORPORATION, Tokyo (JP)

(72) Inventors: Iifan TYOU, Tokyo (JP); Tomoaki WASHIO, Tokyo (JP); Naoto KIRIBUCHI, Tokyo (JP); Nami ASHIZAWA, Tokyo (JP); Ryohei SUZUKI, Tokyo (JP)

(73) Assignee: NIPPON TELEGRAPH AND TELEPHONE CORPORATION, Tokyo (JP)

(21) Appl. No.: 18/873,622

(22) PCT Filed: Jun. 14, 2022
(86) PCT No.: PCT/JP2022/023864

§ 371 Date: Dec. 10, 2024

(51) Int. Cl. H04L 9/32

(52) U.S. Cl. CPC H04L 9/3247

(57) ABSTRACT

In a signature system,

a transmitting terminal having transmitted information requests a signature terminal that trusts the transmitting terminal to provide a signature for the information,

the signature terminal generates the signature for the information, and

in order to confirm that the information existed at a certain point in time, a verification terminal acquires the signature and verifies the signature.

### TECHNICAL FIELD

The present invention relates to a method for certifying the existence of transmitted information without using a trusted third party.

### BACKGROUND ART

There is a case where it is necessary to certify that information that has been posted on social media or information that has been disclosed by a server truly existed at a certain point in time. Although such certification of existence can be performed by using a trusted third party, use of a trusted third party leads to making the procedure complicated and increased cost.

Therefore, for example, existence may be certified by storing information transmitted to a transaction of the block chain disclosed in NPL 1 or the like. Thus, certification of existence can be realized without using a trusted third party.

### CITATION LIST

### Non Patent Literature

NPL 1: Bitcoin: A Peer-to-Peer Electronic Cash System https://bitcoin.org/bitcoin.pdf
NPL 2: Wikipedia—Web of trust https://en.wikipedia.org/wiki/Web_of_trust
NPL 3: Kamvar, S. D.; Schlosser, M. T.; Garcia-Molina, H. (2003). “The eigentrust algorithm for reputation management in p2p networks.” Proceedings of the 12th International Conference on World Wide Web. Retrieved 5 Jul. 2015.

### SUMMARY OF INVENTION

### Technical Problem

However, when the block chain disclosed in NPL 1 or the like is used, an incentive for executing a proof-of-work (POW) or the like is required, and paying this incentive is very costly.

Further, NPLs 2 and 3 disclose a trust propagation technique for verifying trust by following a trust chain, but the conventional trust propagation technique does not perform existence certification.

The present invention was made in view of the above points, and an object thereof is to provide a technique for certifying the existence of information at low cost, without using a trusted third party.

### Solution to Problem

According to the technique disclosed herein, a transmitting terminal having transmitted information requests a signature terminal that trusts the transmitting terminal to provide a signature for the information, the signature terminal generates the signature for the information, and, in order to confirm that the information existed at a certain point in time, a verification terminal acquires and verifies the signature.

### Advantageous Effects of Invention

According to the technique disclosed herein, there is provided a technique for certifying the existence of information at low cost, without using a trusted third party.

### BRIEF DESCRIPTION OF DRAWINGS

FIG. 1 is a diagram showing a configuration example of a system.

FIG. 2 is a diagram showing a configuration example of a system.

FIG. 3 is a diagram showing a configuration example of a terminal.

FIG. 4 is a diagram showing a configuration example of a terminal.

FIG. 5 is a sequence diagram showing a processing operation of a system.

FIG. 6 is a diagram showing an example of a hardware configuration of a device.

### DESCRIPTION OF EMBODIMENTS

Hereinafter, embodiments of the present invention (the present embodiments) will be described with reference to the drawings. The embodiments to be described hereinafter are merely examples and embodiments to which the present invention is applied are not limited to the following embodiments.

The following embodiments describe existence certification for certifying that information posted on social media was actually posted (existed) at a certain point in time, which is an example of an applicable field of technology according to the present invention. The technique according to the present invention can be applied to certification of existence of information, which is not limited to posted information. Such information may also be referred to as “transmission information”.

For example, when information is disclosed on a certain website at a certain point in time, a user who wishes to confirm the existence of the disclosed information can obtain a signature for the disclosed information by using the technique according to the present invention, thereby confirming the existence of the disclosed information. In the following description, an “electronic signature” may be referred to as a “signature”. In general, “existence certification” means that the existence of information is certified for others, and “existence confirmation” means that the user himself/herself confirms that the information actually exists, but these terms may be used interchangeably.

### Outline of Embodiments

First, the outline of the present embodiment will be described. In information posted on social media (e.g., articles, reviews, etc.), for example, the fact that a review that raises an issue about a given product's defect was written before the problem became public knowledge, becomes important at a time of evaluating the value of the review after the problem becomes public knowledge. For the above, it is necessary to certify that the review had existed before the product's defect actually became public knowledge.

An electronic signature has been conventionally used to certify the existence of data. In order to confirm the existence by an electronic signature, the signer needs to be trusted. In order to certify the trust level of the signer, there is a method using a third party such as a certificate authority. Since the method involves complicated procedures and is costly, existence certification is performed by a distributed (non-concentrated) system without arranging a trusted third party.

As a distributed system, for example, it is considered that information on a target of existence certification is entered in a transaction of a block chain as in NPL 1, but this method is costly.

Therefore, in the present embodiment, a network with a trusted peer-to-peer relationship (a network capable of trust propagation) is utilized by techniques such as those of NPLs 2 and 3. That is, the connection between users (terminals) on social media is regarded as a network with a trust relationship in trust propagation, and this network is used. The information poster transmits the posted information to be subjected to existence certification to a user who trusts the information poster, to receive a signature. Further, the user who trusts the information poster transmits the posted information to a user who trusts the user, to receive a signature. This process is repeated. The signatures are shared between the signers and the information source, and each user holds the shared signatures in his/her own block chain (referred to as “local chain”).

A user who wishes to certify the existence (existence certification) for the posted information acquires the signatures and verifies the signatures. When performing existence confirmation (existence certification) for the posted information, the signatures of the persons who have signed (trusted persons) may be verified, and the signature of another person in the local chain owned by the trusted persons may be verified.

Hereinafter, a system configuration and operations according to the present embodiment will be described in detail. In the following description, the terminal may be referred to as “user,” “ . . . er” (e.g., a signer), or the like.

### System Configuration

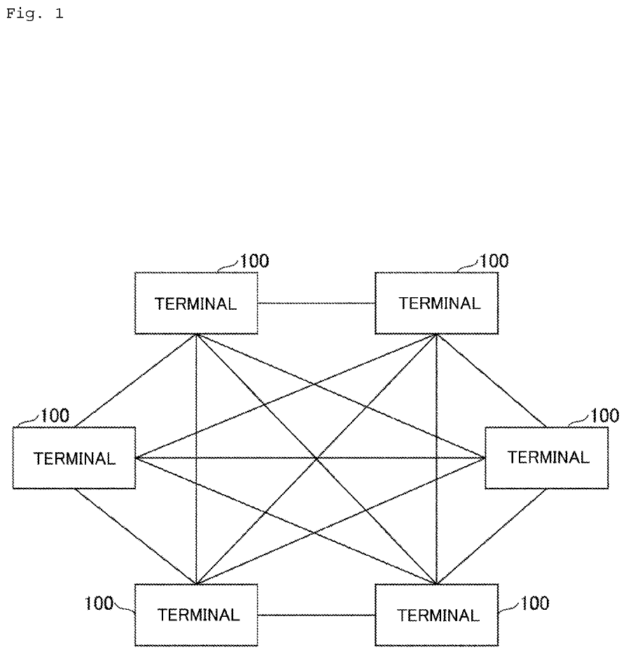

FIG. 1 shows an example of the system configuration according to the present embodiment. In this system, a plurality of terminals 100 are connected to a network, and each terminal 100 can communicate with another terminal 100 in a peer-to-peer manner. Note that a “terminal” may be referred to as a “client terminal”. Although six terminals 100 are shown in FIG. 1, this is an example, and more terminals can actually exist.

A terminal 100 may be any device (computer), but the terminal 100 is, for example, a smartphone, a tablet, or a PC (personal computer).

In the present system, each terminal 100 has a trust level, which indicates to what extent the terminal 100 trusts another terminal 100, for every different terminal 100, according to the technique disclosed in, for example, NPLs 2 and 3. Each terminal 100 also has a trust level held by every different terminal 100.

This trust may be automatically calculated based on the transmission and reception of files between the terminals, or may be set based on a user input (e.g., the input of “like” or a negative evaluation for a certain user on social media).

In calculating the trust level of a certain terminal 100A for another terminal 100B, how much the terminals 100 other than the terminal 100A trust the terminal 100B has an impact as well.

For example, when a terminal 100b evaluates the trust level of a terminal 100a unknown to the terminal 100b, to what extent each terminal 100 trusts the terminal 100a is calculated by following the trust path such as a terminal 100c that the terminal 100b trusts, a terminal 100d that the terminal 100c trusts, and so on.

For example, when the trust level of the terminal 100A seen from the terminal 100B is higher than a threshold, it means that “the terminal 100A trusts the terminal 100B” (a user A trusts a user B). It is assumed that such a trust relationship is constructed in the network shown in FIG. 1. Such a network may be referred to as “web of trust,” “trust propagation-enabled network,” or the like.

In this system, information posted (transmitted) from a certain terminal 100 can be shared with another terminal 100. That is, information posted from a certain terminal 100 is displayed on another terminal 100. The number of other terminals 100 sharing the information may be one or more.

The sharing of the posted information (transmission information) as described above may be realized by performing peer-to-peer communication between the terminals 100, or may be realized by acquiring (displaying) the posted information by providing an information server and accessing the information server by each terminal 100. In either method, the operation at the time of signing and the operation at the time of signature verification, which will be described later, are basically the same.

### Device Configuration

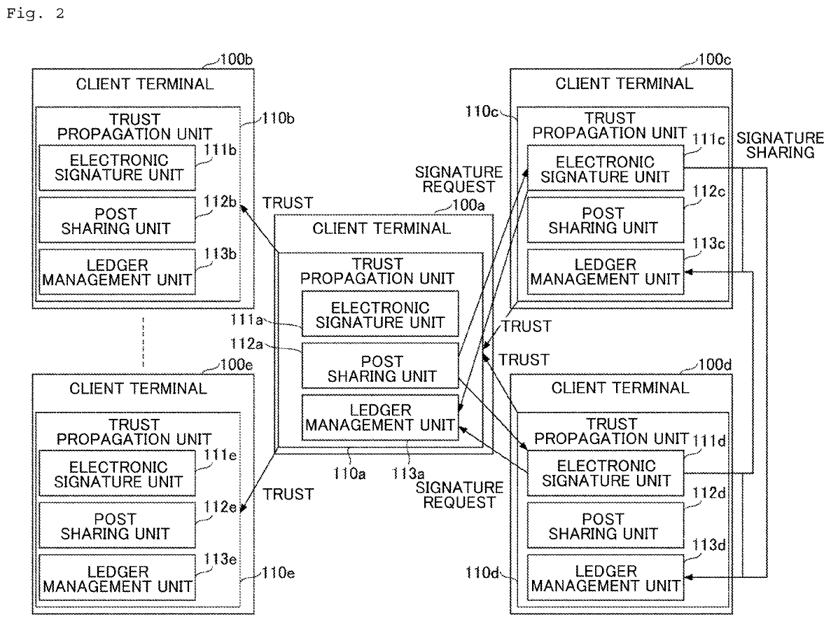

Next, an example of a device configuration of the terminal 100 will be described. FIG. 2 shows a configuration example of a system describing a configuration of each terminal 100. FIG. 2 shows examples of a trust relationship (e.g., the terminal 100a trusts a terminal 100), a signature request (e.g., the terminal 100a requests the terminal 100c for a signature), and signature sharing (e.g., the terminal 100c and the terminal 100d share a signature).

Since the configurations of the respective terminals 100 are the same, symbols excluding “a,” “b” and the like in reference numerals such as “100a” and “100b” are used to describe the configuration of the terminals 100 below.

As shown in FIG. 2, a terminal 100 has a trust propagation unit 110. The trust propagation unit 110 includes an electronic signature unit 111, a post sharing unit 112, and a ledger management unit 113.

When performing an operation using, for example, the electronic signature unit 111, the post sharing unit 112, and the ledger management unit 113, the trust propagation unit 110 provides a user interface for allowing a user to input information or displaying information to the user. Also, it is assumed that the trust propagation unit 110 always (e.g., periodically) performs processing related to the construction of a trust relationship (e.g., trust calculation). The trust propagation unit 110 also transmits and receives data.

The electronic signature unit 111 signs the information for which a signature request is received. Basically, signing is to encrypt the hash value or the like of the information to be signed with a secret key (signature key) held by the user himself/herself, and the encrypted information is referred to as a “signature”. The electronic signature unit 111 can also acquire a signature from a terminal having the signature and verify the signature.

Further, in the present embodiment, it is possible to provide a ring signature (or a “group signature”) for providing a plurality of signatures for one piece of information, and the electronic signature unit 111 is able to sign one signature in the ring signature (or group signature).

Further, the electronic signature unit 111 can provide a time stamp signature for the information. The time at which the information is posted can be certified by the time stamp signature. Any method may be used for the method of time stamp signature. For example, a time stamp signature can be provided by performing time adjustment among a plurality of terminals 100, attaching a time stamp by using that time, and signing the time stamp.

Further, the signature for the information and the time stamp signature may be separately performed, or the time stamp signature may be included in the signature for the information. The following description is made on the assumption that a time stamp signature is included in the signature for the information.

The post sharing unit 112 has a function of posting information and a function of displaying (browsing) information posted from another user.

The post sharing unit 112 holds and manages information on trust relationship in a storage unit such as a memory. For example, the post sharing unit 112 updates the information on the trust relationship when there is a change in the trust relationship. The information related to the trust relationship is, for example, a user (terminal) whom the poster trusts and its address, and a user who trusts the poster and its address. As the information on the trust relationship, information on a follow relationship on social media may be used.

The post sharing unit 112 determines that “a user who trusts the poster” as a sharing person of the information =a signer when the information is posted, shares the information with the user thereof, and requests the user to provide an electronic signature. The “share information with the user” may mean transmitting the information to the user.

When the information is posted, the poster himself/herself may or may not participate in signing for the information. The poster participates in signing, thereby facilitating presentation of a signature from the poster to the verifier.

The ledger management unit 113 holds and manages the ledger of the local chain closed in each terminal in a storage unit such as a memory. The local chain is, for example, a chain in which a plurality of blocks having one or more signatures are connected. Each block includes, for example, a hash value of a block of a connection source, and is configured to make it difficult to alter a local chain. The local chain may be referred to as “a signature chain”.

As an operation that is performed at the time of signing, the ledger management unit 113 acquires a signature of each user who has participated in signing for the posted information, and connects the signature to a local chain as a block, together with his/her own signature. The signature of the user is transmitted to each of the other users who have participated in signing.

That is, the ledger management unit 113 shares the latest state of the ledger with other users when participating in signing. Further, the ledger management unit 113 may generate a new signature based on the information (e.g., his/her own signature and signatures of the others for the posted information), and connect the new signature to a signature chain in the ledger to be managed. Thus, higher safety can be ensured.

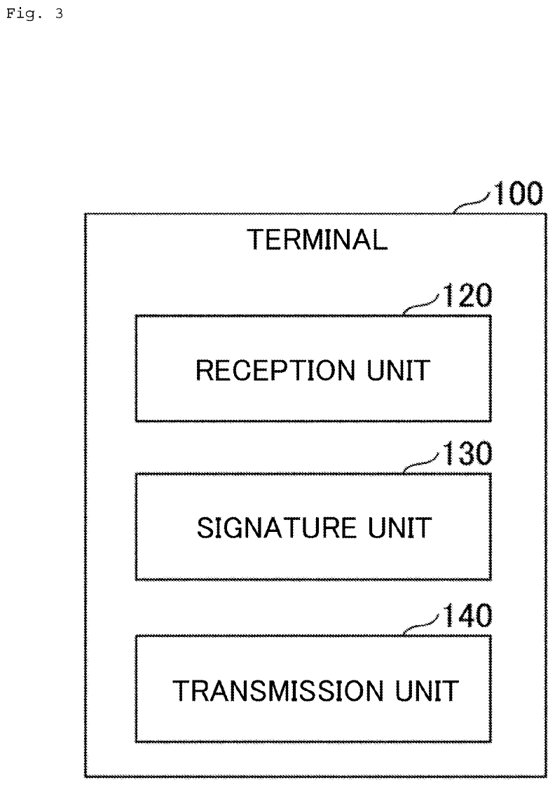

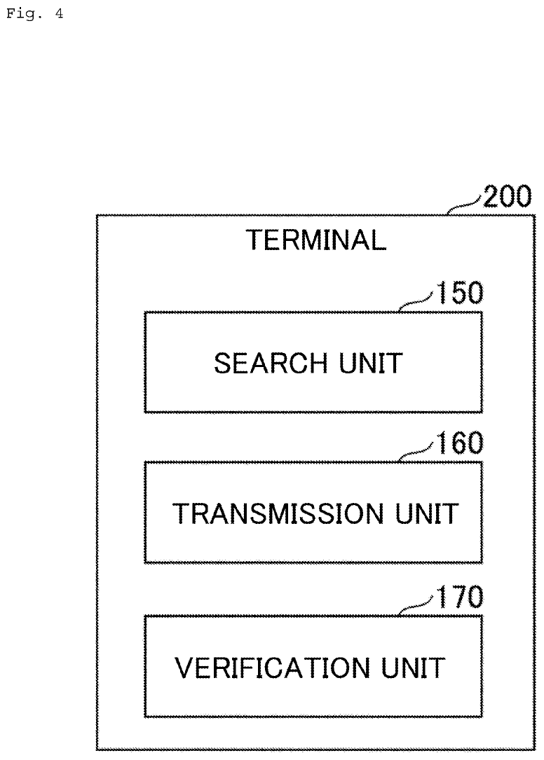

In addition, focusing on the operation performed at the time of signing by the terminal 100 and the operation performed at the time of verification, the configuration of the terminal 100 can be shown as in FIG. 3 (signature terminal) and FIG. 4 (verification terminal).

The terminal 100 shown in FIG. 3 includes a reception unit 120 for receiving a request for a signature for information transmitted from a transmitting terminal, from the transmitting terminal, a signature unit 130 for generating a signature for the information based on the request, and a transmission unit 140 for transmitting the signature to a verification terminal based on a signature presentation request from the verification terminal.

The terminal 100 shown in FIG. 4 includes a search unit 150 for searching for a trust path in a web of trust to detect one or more signature terminals that directly or indirectly trust a transmitting terminal that has transmitted information, a transmission unit 160 for transmitting the signature presentation request to each signature terminal detected by the search unit 150, and a verification unit 170 for acquiring a signature from each signature terminal of a transmission destination of the signature presentation request, and verifying each signature, thereby confirming the existence of the information.

### Processing Sequence

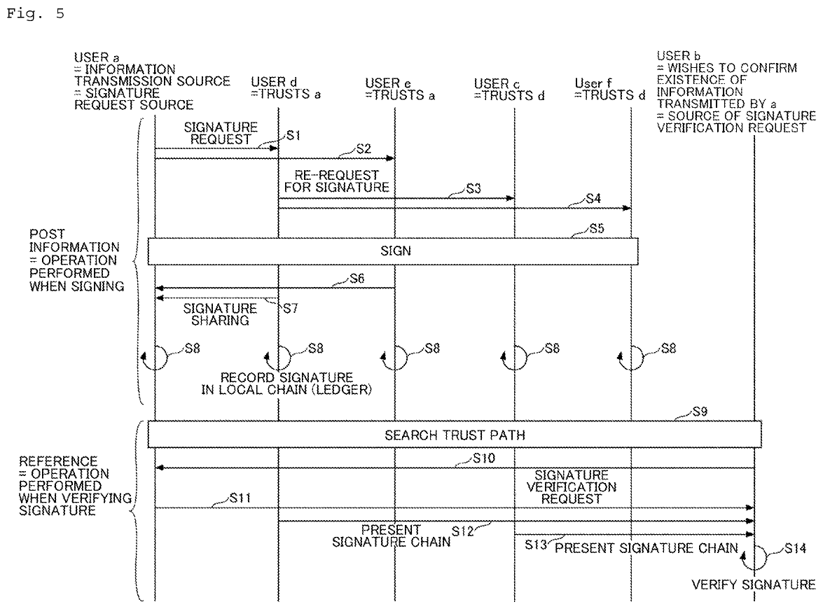

An example of a sequence of the system according to the present embodiment will be described next with reference to FIG. 5. The “user” in the description of FIG. 5 may be replaced by “terminal 100”. In FIG. 3, it is assumed that a user a posts information, and a user b confirms the existence of the information (e.g., whether the information was actually posted before a certain date). In the operation of each user (each terminal) described below, as to the operation of signing, the posted information may be displayed on a display unit of the terminal to perform the signing by a user operation (person) or automatically by the terminal.

In S1, a post sharing unit 111a of the user a posts information and requests each of a user d and a user e who trusts the user a, for a signature for the posted information. The posted information itself may be shared (distributed) to each user or shared (distributed) only to a signer regardless of whether or not the user (poster) is trusted. The user who has shared (distributed) the posted information can access the posted information in his/her own terminal or can access the posted information by accessing an information server.

A post sharing unit 112d of the user d receiving the signature request requests a user c and a user f who trust the user d to provide a signature on the posted information. Since this is the second signature for the posted information, “signature re-request” is described in FIG. 3.

It is not necessary all the users connected in the web of trust provide signatures. For example, the user who made a request for a signature first may designate the number of stages for following the trust path, and the designated value may be notified to each signature request destination of each stage together with the signature request. Further, the signature request may include the number of stages of the trust path that that signature request has passed thus far.

For example, it is assumed that A is an information poster and the trust path is A->B->C->D->E. In addition, A->B indicates that B trusts A.

Here, if the number of stages for following the trust path is 1, the signature requesting operation is completed only by “A->B” (A requests B for a signature). When the number of stages for following the trust path is 2, the signature requesting operation is completed by “A->B->C”. At this time, C recognizes that the two stages have already been passed by the signature request received by the C himself/herself, and therefore does not send any further signature request. By such processing, the generation of an unnecessarily large number of signature requests can be avoided.

Further, the information poster may point out the total number of signers (and which signers provide signatures). Further, when the same user always signs, there is a possibility that camouflage is done by coalition, so that randomness may be provided when the signer is selected.

In the example shown in FIG. 5, each signer signs the posted information by the electronic signature unit 111 in S4. The signature may be a ring signature or group signature. The signer may sign immediately after receiving the signature request, and send a signature re-request after signing.

Then, each user who has signed shares the signature with each of the other users who has signed. FIG. 3 shows that the user a acquires the signature of the user d and the signature of the user e as an example of the signature sharing operation.

For example, with A being defined as an information poster, it is assumed that each of B, C, and D has signed for the posted information following the trust path A->B->C->D. Each signature may be a signature in a ring signature (or group signature) or may be a single (normal) signature.

In this case, by signature sharing, A acquires “the signature of B, the signature of C, and the signature of D”. Similarly, B, C, and D each acquire “the signature of B, the signature of C, and the signature of D”. This is an example, and each user participating in signing may acquire a part (for example, two out of three) of all the signatures provided for the posted information, by means of signature sharing.

In S8, each user participating in signing connects the signature acquired by sharing (his/her signature and the signature of another person) to a local chain as a block and holds it.

The signature sharing and recording in a local chain described above may not be performed. Even when the signature sharing and recording in a local chain described above are not performed, each user participating in signing holds a signature for the posted information.

Thereafter, the user b (an electronic signature unit 111b of the user b) who desires to confirm the posted information (transmission information) of the user a basically acquires a signature for the posted information from each user who has participated in signing for the posted information, verifies the signature of each user, and when the signature verification of all users who have participated in signing is successful, determines that the existence of the posted information is confirmed (certified). Since the signature verification includes verification of a time stamp, success of signature verification means that it is certified the posted information was posted prior to a certain point in time, for example.

Note that, as described above, determining that the existence of the posted information has been certified when the signature verification of all the users who have participated in signing is successful, is an example. If signature verification of a number of users equal to or more than a certain threshold among all the users participating in signing is successful, it may be determined that the existence of the posted information is certified. Also, when the number of users whose signatures are verified successfully is larger than the number of users whose signatures are not verified successfully among all the users participating in signing, it may be determined that the existence of the posted information is certified. This corresponds to making a decision by majority decision.

As a more specific processing example, in S9 in FIG. 5, a post sharing unit 112b (or the electronic signature unit 111b) of the user b searches a trust path for the user a who has posted the information. A signer for the posted information of the user a is acquired by searching the trust path. The search of the trust path may be performed inside the user b by using the information of the trust relationship held by the user b himself/herself, or may be performed while inquiring other users about the information of the trust relationship.

Then, in S10, the user b transmits a signature presentation request to a signer or the like for the posted information. The example shown in FIG. 3 shows a request to the user a.

Each user who has received the signature presentation request presents (transmits) a signature to the user b by the post sharing unit 112 (or the electronic signature unit 111) (examples: S11, S12, and S13). Then, the electronic signature unit 111b of the user b verifies the signature of each user (S14). The electronic signature unit 111b previously holds a verification key (public key) necessary for signature.

With respect to the processing of S11, S12 and S13 described above, by each user who has received the signature presentation request using the post sharing unit 112 (or the electronic signature unit 111 or the ledger management unit 113), all or a part of the local chain may be presented (transmitted) to the user b. As described above, the local chain of a certain user includes a signature of the user for the posted information of the user a and a signature of another person other than the user.

The electronic signature unit 111b of the user b which has acquired the local chain of each user verifies the signature of the other person other than the user together with the signature of the user recorded in the local chain of each user.

Since the local chain also includes a past signature (and signatures of others from the past), the past signature (or signatures of others from the past) is compared with the latest signature (or the latest signature of another person), so that, for example, it can be verified whether or not a false certificate account is used for the current signature.

### Exemplary Hardware Configuration

The terminal 100 described above can be realized by, for example, causing a computer to execute a program that describes processing contents to be described in the present embodiment. The computer may be a physical computer or a virtual machine on a cloud.

That is, the terminal 100 can be realized by executing a program corresponding to the processing performed by the terminal 100 using hardware resources such as a CPU and memory built into the computer. The program can be recorded on a computer-readable recording medium (a portable memory or the like) to be stored and distributed. In addition, the above-described program can also be provided through a network such as the Internet or e-mail.

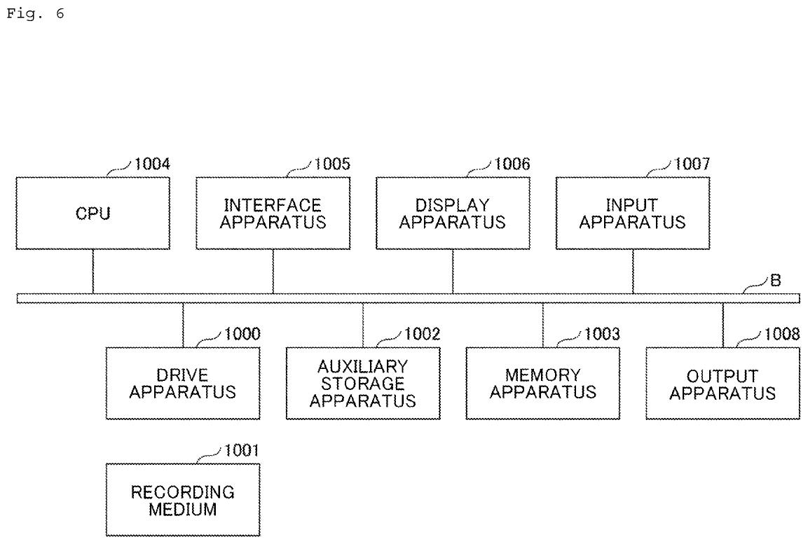

FIG. 6 is a diagram showing an example of a hardware configuration of the above-described computer. The computer shown in FIG. 6 has a drive apparatus 1000, an auxiliary storage apparatus 1002, a memory apparatus 1003, a CPU 1004, an interface apparatus 1005, a display apparatus 1006, an input apparatus 1007, an output apparatus 1008 and the like connected to each other via a bus BS.

The program for realizing processing in the computer is provided by, for example, a recording medium 1001 such as a CD-ROM or a memory card. When the recording medium 1001 which stores the program is set in the drive apparatus 1000, the program is installed in the auxiliary storage apparatus 1002 from the recording medium 1001 via the drive apparatus 1000. However, the program need not necessarily be installed from the recording medium 1001 and may be downloaded from another computer via a network. The auxiliary storage apparatus 1002 stores the installed program and also stores necessary files, data, and the like.

The memory apparatus 1003 reads and stores the program from the auxiliary storage apparatus 1002 when an instruction to start the program is given. The CPU 1004 realizes the functions related to the terminal 100 in accordance with the program stored in the memory apparatus 1003. The interface apparatus 1005 is used as an interface for connecting to a network or the like. The display apparatus 1006 displays a GUI (Graphical User Interface) or the like based on a program. The input apparatus 1007 is composed of a keyboard, a mouse, buttons, a touch panel, and the like and is used for inputting various operation instructions. The output apparatus 1008 outputs a calculation result.

### Summary of Embodiments, Effects, etc

As described above, the technique according to the present embodiment makes it possible to execute certification without increasing the costs by requesting the user who trusts the poster to certify (i.e., sign) the existence of data by utilizing the connection of trust when existence certification is performed in the distributed environment. Further, a user who uses information on a sender (poster) can acquire a signature in a trust path by referring to a signature on a trust path that is referred to when evaluating the trust level of the sender, and can perform highly trusted verification by verifying the signature.

Also, the technique according to the present embodiment has the following features as compared to the prior art. As compared with the block chain technique disclosed in NPL 1 or the like, the technique according to the present embodiment can sign by a processing operation similar to an operation within a trust relationship (=like) without selecting a reader by PoW, PoS or the like. Thus, existence certification can be realized at 0 cost as compared with the methods by PoW, PoS or the like.

In addition, as compared with the trust evaluation techniques disclosed in NPLs 2 and 3, the technique according to the present embodiment can perform trust evaluation for individual information (articles or the like) by signing using trust propagation. Also, by tracing the trust relationship and receiving a signature from a plurality of users, the existence certification by, for example, majority decision on the trust oath can be performed without defining a trusted third party. Further, according to the technique of the present embodiment, the strength of the connection as the trust propagation can also be calculated by the number of signatures, the frequency (the number of signatures), and the like.

A summary (features) of the technique according to the present embodiment (referred to as “present technique”) will be described below. The following features are those of the technique according to the embodiment, and it is not essential that the present invention has all the following features.

The present technique can sign based on a trust relationship in a social network application capable of trust propagation.

Further, in the present technique, by using the above-described local chain, it is possible to prevent the signature participant from being falsified and to secure the possibility of verification.

That is, although it may be difficult to confirm the safety of the trust path itself due to a limited number of signers or a limited trust path to be traced, in such a case each signer holds his/her own signature and/or the simultaneous signature of the other person performed by ring signature system or the like as a local chain in its own terminal in a block chain structure. Thus, it is possible to verify whether or not an account used in the terminal is a camouflage account used in a Sybil attack or the like, by comparing the result of the signature (signature of another person from the past or the like) with the current signature of another person.

Further, the present technique can cope with safety evaluation based on trust propagation, and can extend the accuracy of the trust propagation. That is, although updating and maintenance of a trust relationship are general tasks of a social network capable of trust propagation, since periodic reference and update by a signature are performed by using the present technique, a change in the life-and-death status and the trust relationship of the account can be confirmed by the evidence of the signature of the trusted user. Here, if it is known that the trust relationship is not changed, the processing operation for the trust relationship management can be confirmed and action can be taken.

Further, by using a group signature, a ring signature, an Ont-time public key or the like, signature and existence certification while keeping anonymity of a signer are made possible.

Further, in the present technique, the number of signers for supporting the trust level of the signature can be designated by a signature requesting source (information sender) for requesting for the signature. In addition, when the same user always signs, since there is a possibility of falsification by coalition, randomness can be given in the selection of the signer. Furthermore, the number of signatures required recursively in the case of tracing the trust path can be limited. Thus, safety can be secured, and an unnecessarily large number of signers can be avoided.

### ADDITIONAL REMARKS

The following additional remarks are further disclosed in relation to the embodiments described above.

### Clause 1

A signature system,
in which a transmitting terminal having transmitted information requests a signature terminal that trusts the transmitting terminal to provide a signature for the information,
in which the signature terminal generates the signature for the information, and
in which, in order to confirm that the information existed at a certain point in time, a verification terminal acquires the signature and verifies the signature.

### Clause 2

The signature system according to clause 1, in which the signature terminal requests another signature terminal that trusts the signature terminal to provide a signature for the information.

### Clause 3

The signature system according to clause 1 or 2,
in which a request for the signature for the information is transmitted along a trust path in a web of trust, and
in which the transmitting terminal requests for the signature and designates a number of stages to be performed upon requesting for the signature.

### Clause 4

The signature system according to any one of clauses 1 to 3, in which the signature terminal holds the signature generated for the information as a local chain.

### Clause 5

A terminal including:
a reception unit configured to receive a request for a signature for information transmitted from a transmitting terminal;
a signature unit configured to generate the signature for the information based on the request; and
a transmission unit configured to transmit the signature to a verification terminal based on a signature presentation request from the verification terminal.

### Clause 6

A terminal including:
a search unit configured to search a trust path in a web of trust to detect one or more signature terminals that directly or indirectly trust a transmitting terminal having transmitted information;
a transmission unit configured to transmit a signature presentation request to each of the one or more signature terminals detected by the search unit; and
a verification unit configured to acquire a signature from each of the one or more signature terminals being a transmission destination of the signature presentation request, and verify each signature to confirm existence of the information.

### Clause 7

An existence confirmation method executed by a signature system, the method including:
a step in which a transmitting terminal having transmitted information requests a signature terminal that trusts the transmitting terminal to provide a signature for the information,
a step in which the signature terminal generates the signature for the information, and
a step in which, in order to confirm that the information existed at a certain point in time, a verification terminal acquires the signature and verifies the signature.

### Clause 8

A non-transitory storage medium in which a program for causing a computer to function as each unit in the terminal described in clause 5 or 6 is stored.

Although the embodiments have been described above, the present invention is not limited to such specific embodiments, and various modifications and changes can be made within the scope of the gist of the present invention described in the claims.

### REFERENCE SIGNS LIST

100 Terminal
110 Trust propagation unit
111 Electronic signature unit
112 Post sharing unit
113 Ledger management unit
120 Reception unit
130 Signature unit
140 Transmission unit
150 Search unit
160 Transmission unit
170 Verifying unit
1000 Drive apparatus
1001 Recording medium
1002 Auxiliary storage apparatus
1003 Memory apparatus
1004 CPU
1005 Interface apparatus
1006 Display apparatus
1007 Input apparatus
1008 Output apparatus

1. A signature system comprising:
a transmitting terminal including a memory and a processor coupled to the memory;
a first signature terminal including a memory and a processor coupled to the memory; and
a verification terminal including a memory and a processor coupled to the memory,
wherein the processor of the transmitting terminal having transmitted information requests a first signature terminal that trusts the transmitting terminal to provide a signature for the information,
wherein the processor of the first signature terminal generates the signature for the information, and
wherein, in order to confirm that the information existed at a certain point in time, the processor of the verification terminal acquires the signature and verifies the signature.

2. The signature system according to claim 1, wherein the processor of the first signature terminal requests a second signature terminal that trusts the first signature terminal to provide a signature for the information.

3. The signature system according to claim 1,
wherein a request for the signature for the information is transmitted along a trust path in a web of trust, and
wherein the processor of the transmitting terminal requests for the signature and designates a number of stages to be performed upon requesting for the signature.

4. The signature system according to claim 1, wherein the processor of the first signature terminal holds the signature generated for the information as a local chain.

5. A terminal comprising:
a reception circuit configured to receive a request for a signature for information transmitted from a transmitting terminal;
a signature circuit configured to generate the signature for the information based on the request; and
a transmission circuit configured to transmit the signature to a verification terminal based on a signature presentation request from the verification terminal.

6. A terminal comprising:
a search circuit configured to search a trust path in a web of trust to detect one or more signature terminals that directly or indirectly trust a transmitting terminal having transmitted information;
a transmission circuit configured to transmit a signature presentation request to each of the one or more signature terminals detected by the search circuit; and
a verification circuit configured to acquire a signature from each of the one or more signature terminals being a transmission destination of the signature presentation request, and verify each signature to confirm existence of the information.

7. An existence confirmation method executed by the signature system of claim 1, the method comprising:
requesting, by the transmitting terminal having transmitted the information, the first signature terminal that trusts the transmitting terminal to provide the signature for the information,
generating, by the first signature terminal, the signature for the information, and
acquiring the signature and verifying the signature, by the verification terminal, in order to confirm that the information existed at the certain point in time.

8. A non-transitory computer-readable recording medium having a program embodied therein for causing a computer to function as the terminal of claim 5.
